(19) United States
(12) Patent Application Publication
(10) Pub. No.: US 2021/0194598 A1
(43) Pub. Date: Jun. 24, 2021

(54) ENERGY TRANSFER DEVICE, ENERGY HARVESTING DEVICE, AND POWER BEAMING SYSTEM

(71) Applicant: Antoine FELICELLI, Thonex (CH)

(72) Inventors: Nicolas MALPIECE, Rosières-Aux-Salines (FR); Pascal GALLO, Yens (CH)

(21) Appl. No.: 16/757,912

(22) PCT Filed: Oct. 22, 2018
(86) PCT No.: PCT/IB2018/058202

§ 371 Date: Apr. 21, 2020

(30) Foreign Application Priority Data
Oct. 23, 2017 (IB) PCT/IB2017/056563

(51) Int. Cl. H04B 10/80; H02J 50/30; H02J 50/80; H02J 50/90

(52) U.S. Cl. CPC H04B 10/807; H02J 50/90; H02J 50/80; H02J 50/30

(57) ABSTRACT

The present invention concerns an energy transfer device for transferring replenishment energy to a distant object, the energy transfer device comprising: —an energy source, —a base configured to hold the energy source and to orient the energy source towards the distant object, wherein the energy source comprises at least one Vertical External Cavity Surface Emitting Laser.

### CROSS-REFERENCE TO RELATED APPLICATIONS

The present application claims priority to International Patent Application n° PCT/IB2017/056563 filed on Oct. 23 2017, the entire contents thereof being herewith incorporated by reference.

### FIELD OF THE INVENTION

The present invention relates to the field of power beaming or providing an energy transporting beam to a distant object to provide energy to the object. A system to achieve power beaming is disclosed herein.

### BACKGROUND

Power beaming consists in sending energy to a remote object, either fixed or in motion. Energy is preferably sent via electromagnetic waves. These waves are transmitted through a medium, usually the atmosphere, reaching a receptor that converts them into electricity. The electricity powers batteries, or electrical engines, or any device embarked onto the object. The transmission of wireless power was demonstrated by Tesla. In the mid-20^{th} century, research focused on the microwaves power transmission. William Brown demonstrated a helicopter powered by microwave beam in 1964. Other aircraft prototypes using microwaves were designed. The microwave beam dispersion limits this technology. More recently, this technique has moved to another wavelength range. The first small-scale aircraft powered by a laser was developed by NASA in 2003. The source is the strategic element of the system, so its quality and the shape of the beam are essential.

The power received by the object should be such that it enables charging the object's batteries, or directly power the engine or any embarked device. Among other parameters, the power received by the object depends on the distance from the object to the electromagnetic wave source, the transmission of the medium at the emitted wavelength, and the divergence of the beam.

The beam is oriented toward the moving object. The simplest solution is to generate a high intensity fixed beam and use an active element like mirrors that directs the beam (see WO2008045439, US2005190427). The issue with this solution is the fast degradation of the active element, since the laser radiation incident on the active element is very intense. Since the mirror on the active element is not 100% reflective, a part of the radiation is absorbed, and a part generates heat, that deteriorates the mirror and/or the active element itself. A solution to overcome this issue is to direct the beam towards the receiving object, without any intermediate active element, in which case the overall system reliability will be improved.

In addition, the beam must be collimated to optimize the transfer of energy and increase the transmission distance. Indeed, if the laser beam is not perfectly collimated, the laser beam diameter increases with the distance from the source, and can eventually become larger than the photodiode elements mounted on the receiving object. In this case, the power received by the receiving object decreases with the distance from the source. Obtaining a collimated laser beam is not straightforward, in particular with high intensities. In the ideal case, the laser beam should be as close to a perfectly Gaussian beam, in the fundamental mode, so that collimating optics could operate in the most efficient way. This configuration is difficult to implement with a high intensity laser. To obtain such a beam, a possibility is to use vertical cavity laser matrices. However, this requires a large number of lenses to shape the beam and limit beam divergence (see WO2016187328). Moreover, the emission power of such vertical cavity lasers is intrinsically limited. Furthermore, lasing action in these devices is very sensitive to temperature changes that occur at high emission powers, the cavity resonance is shifted by the temperature change and the lasing wavelength is modified or the lasing action is lost if a strict temperature control is not maintained. The sources can also be bundled but losses are introduced (see US2015311755).

Safety considerations should be taken into account. Generally, exposure to the laser beam emitted should not be hazardous.

When a large number of moving objects, such as drones or UAVs (unmanned aerial vehicles), require energy replenishment via power beaming, a high rate of energy replenishment and a short replenishing time per object is required. Larger individual moving objects can also require significant continuous transmitted power. Currently known power beaming systems do not permit a high rate of energy replenishment and a sufficiently short replenishing time; also, they cannot provide enough power to permit complete autonomy of larger drones or UAVs, thus making it necessary to provide large numbers of replenishing devices to assure quick refueling or complete autonomy.

### SUMMARY

It is therefore one aspect of the present disclosure to provide an energy transfer device according to claim 1, an energy harvesting device according to claim 29, an unmanned aerial vehicle or drone including the energy harvesting device according to claim 41, and a power beaming system according to claim 42 that overcome the above problems and conforms to the above challenges. The present disclosure also concerns a power beaming method carried out using the power beaming system.

Other advantageous features can be found in the dependent claims.

According to an aspect of the present disclosure, the energy transfer device comprises an energy source, and a base configured to hold the energy source and to orient the energy source towards the distant object. The energy source comprises at least one Vertical External Cavity Surface Emitting Laser (VECSEL).

According to another aspect of the present disclosure, the base is configured to displace the energy source relative to the base to orient the energy source towards the distant object.

According to another aspect of the present disclosure, the energy source comprises an array including a plurality of Vertical External Cavity Surface Emitting Lasers, and the base is configured to hold the energy source and to orient the energy source towards the distant object.

According to another aspect of the present disclosure, the base includes a mobile device configured to be displaced, the at least one Vertical External Cavity Surface Emitting Laser (VECSEL) or the plurality of Vertical External Cavity Surface Emitting Lasers (VECSEL) being mounted directly on the mobile device being displaced with the mobile device.

According to another aspect of the present disclosure, the mobile device further includes collimating optical elements for collimating the laser emission of the at least one Vertical External Cavity Surface Emitting Laser (VECSEL) or the plurality of Vertical External Cavity Surface Emitting Lasers (VECSEL), the collimating optical elements being mounted directly on the mobile device being displaced with the mobile device.

According to another aspect of the present disclosure, the at least one or plurality of Vertical External Cavity Surface Emitting Lasers (VECSEL) comprise or comprises an external optical cavity in which is located a semiconductor active region configured to emit laser light at a first wavelength when optically pumped by a pumping laser providing laser energy at a second shorter wavelength.

According to another aspect of the present disclosure, the at least one or plurality of Vertical External Cavity Surface Emitting Lasers (VECSEL) is or are configured to be optically pumped for laser emission along a laser emission output axis, or at an angle to the laser emission output axis.

According to another aspect of the present disclosure, the at least one or plurality of Vertical External Cavity Surface Emitting Lasers (VECSEL) include or includes a semiconductor action region and an optical cavity formed by mirrors not in direct contact with the semiconductor active region and defining a space within the optical cavity.

According to another aspect of the present disclosure, the at least one or plurality of Vertical External Cavity Surface Emitting Lasers (VECSEL) includes or include an optical cavity, at least one semiconductor active region for emitting light inside the optical cavity and at least one low thermal impedance element for evacuating thermal energy, the at least one semiconductor active region being in direct contact with the at least one low thermal impedance element inserted inside a cavity.

According to another aspect of the present disclosure, the at least one low thermal impedance element includes at least one high contrast grating.

According to another aspect of the present disclosure, the Energy transfer device includes a first thermal impedance element including a high contrast grating and a second thermal impedance element including a high contrast grating, the first and/or second thermal impedance elements being in direct contact with the at least one semiconductor active region, and the high contrast gratings reflecting light into an optical cavity inside which the at least one semiconductor active region is located.

According to another aspect of the present disclosure, the at least one low thermal impedance element or each thermal impedance element comprises or consists solely of diamond.

According to another aspect of the present disclosure, the at least one or plurality of Vertical External Cavity Surface Emitting Lasers (VECSEL) includes or includes at least one heat sink in contact with the at least one or each low thermal impedance element.

According to another aspect of the present disclosure, the Energy transfer device further includes a plurality of pumping lasers arranged to surround an active region of one Vertical External Cavity Surface Emitting Laser (VECSEL) or each one of the Vertical External Cavity Surface Emitting Laser (VECSEL) to simultaneously optically pump the active layer.

According to another aspect of the present disclosure, the at least one or plurality of Vertical External Cavity Surface Emitting Lasers (VECSEL) is or are configured to emit light at a wavelength comprised between 1 μm and 3 μm.

According to another aspect of the present disclosure, the at least one or plurality of Vertical External Cavity Surface Emitting Lasers (VECSEL) is or are configured to operate in a continuous or in a pulsed mode.

According to another aspect of the present disclosure, the at least one or plurality of Vertical External Cavity Surface Emitting Lasers (VECSEL) is or are configured to emit laser light in a single optical mode.

According to another aspect of the present disclosure, the Energy transfer device further includes a RF transmitter and RF receiver for communicating with the distant object.

According to another aspect of the present disclosure, the energy transfer device is further configured to receive geographical position data of the distant object from the object by RF communication and to orient the energy source emission towards said received geographical position.

According to another aspect of the present disclosure, the energy transfer device is further configured to set the emission power level of the energy source to (i) an alignment level during an alignment period in which an energy receiver (R) of the object is being aligned to a beam of the energy source to permit optimal energy transfer, and (ii) an energy transfer level during which energy replenishment of the object is carried out.

According to another aspect of the present disclosure, the energy transfer device is further configured to modulate the emission of the energy source during an alignment period to allow the object to identify the Energy transfer device.

According to another aspect of the present disclosure, the energy transfer device is configured to displace the energy source to sweep or scan the emission beam of the energy source in a predefined zone to permit alignment of the beam with the distant object.

According to another aspect of the present disclosure, the energy transfer device is configured to determine from a signal received from the object that energy reception has occurred, and to displace the energy source in reaction to a received alignment signal from the object representing an alignment level to optimise a received energy level at the object.

According to another aspect of the present disclosure, the energy transfer device is configured to set the emission power level of the energy source to the energy transfer level higher than the alignment level and to continuous operation to energy replenish the object; and/or the energy transfer device is configured to operate in a high power mode, and configured to adjust the power of the source to fit the distant object that needs to be replenished.

According to another aspect of the present disclosure, the energy transfer device is configured to stop or block emission from the energy source in response to a safety signal received from the object signalling a drop in received energy below a predetermined threshold value.

According to another aspect of the present disclosure, the Energy transfer device further includes a network communications device configured to communicate status data of the energy transfer device to a central network controller configured to coordinate energy replenishment of a fleet of objects.

According to another aspect of the present disclosure, the device is configured to transfer replenishment energy over free-space to distant object.

According to another aspect of the present disclosure, the distant object is an unmanned aerial vehicle (UAV) or drone.

It is yet another aspect of the present disclosure to provide an Eenergy harvesting device for collecting replenishment energy for an object. The energy harvesting device comprises an energy receiver configured to capture electromagnetic radiation energy from at least one Vertical External Cavity Surface Emitting Laser (VECSEL) or a plurality of Vertical External Cavity Surface Emitting Lasers, an energy converter configured to convert the received energy into electrical energy to power the object, and a base configured to hold at least the energy receiver and the energy converter, and configured to orient at least the energy receiver towards the at least one Vertical External Cavity Surface Emitting Laser (VECSEL) or the plurality of Vertical External Cavity Surface Emitting Lasers.

According to another aspect of the present disclosure, the energy converter is further configured to provide the converted energy to the object.

According to another aspect of the present disclosure, the receiver is configured to capture electromagnetic radiation energy at a wavelength comprised between 1 μm and 3 μm.

According to another aspect of the present disclosure, the Energy harvesting device further includes a RF transmitter and RF receiver for communicating with an energy transfer device providing the electromagnetic radiation energy.

According to another aspect of the present disclosure, the energy harvesting device is further configured to determine its geographical position data and communicate said data to an energy transfer device providing the electromagnetic radiation energy.

According to another aspect of the present disclosure, the energy harvesting device is further configured to demodulate a received emission signal from the at least one Vertical External Cavity Surface Emitting Laser (VECSEL) or the plurality of Vertical External Cavity Surface Emitting Lasers, and to identify the Energy transfer device operating the at least one Vertical External Cavity Surface Emitting Laser (VECSEL) or the plurality of Vertical External Cavity Surface Emitting Lasers from the demodulated signal.

According to another aspect of the present disclosure, the energy harvesting device is further configured to communicate an alignment signal to an energy transfer device providing the electromagnetic radiation energy confirming that energy reception has occurred.

According to another aspect of the present disclosure, the energy harvesting device is further configured to determine an alignment figure of merit value based on a distribution of received energy on the receiver, and to communicate an alignment signal to an energy transfer device providing the electromagnetic radiation energy to guide displacement of a received emission beam by the energy transfer device, said alignment signal being determined based on said alignment figure of merit value.

According to another aspect of the present disclosure, the energy harvesting device is further configured to determine a drop in received energy below a predetermined threshold value, and to communicate a safety signal to an energy transfer device providing the electromagnetic radiation energy signalling a drop in received energy below a predetermined threshold value.

According to another aspect of the present disclosure, wherein the energy harvesting device is further configured to communicate with a mobile communications network to receive geographical position data of one or more energy transfer devices for providing replenishing electromagnetic radiation energy.

According to another aspect of the present disclosure, the energy harvesting device is further configured to communicate with a mobile communications network to receive geographical position data of one or more energy transfer devices currently available to provide replenishing electromagnetic radiation energy.

According to another aspect of the present disclosure, the base includes a mobile device configured to mount a receiver thereon so that a receiver surface can be orientated to be positioned relative to the laser beam.

The present disclosure also concerns an Unmanned aerial vehicle or drone including the Energy harvesting device.

The present disclosure also concerns a power beaming system including the energy transfer device, and the energy harvesting device.

The energy transfer device, the energy harvesting device, and the power beaming system in particular permit a high rate of energy replenishment and a short replenishing time permitting to minimize the number of required replenishing devices.

Vertical External Cavity Surface Emitting Lasers (VECSELs) included in the power beaming system have the advantage of power, low divergence, efficiency and compactness. VECSELs, in particular, are so compact that they can be directly mounted onto the moving platform that directs the laser beam towards the receiver.

VECSELs in particular, also provide a wavelength to which eye and skin are more tolerant, and are used in combination with procedures to cut the laser in circumstances where beam interception or loss is suspected.

The diameter and the interruption time of the beam are important for safety reasons. In order to reduce the power density, light intensity per unit area, the diameter of the beam can be greater than 10 cm. As to the exposure time, i.e. the time that an individual or object is exposed to the beam, it must be as short as possible. This time is less than 1 s taking into account the time of detection by the UAV and transmission of the information to the transmitter. The use of a VECSEL or VECSELs allow this to be achieved.

Power beaming consists in sending energy to a remote object through electromagnetic waves. The object is generally equipped with a receiver that converts the electromagnetic waves into electricity, which feeds batteries or electrical engines. The object is either fixed or in motion, manned or unmanned. The electromagnetic wave source is preferably powerful to send as much energy as possible; its divergence should be low so that the beam cross-section depends as less as possible on the distance between the object and the source. The transmission medium, usually the atmosphere, is preferably transparent (or highly transparent) to the electromagnetic wave. For all these reasons, one of the most pertinent sources is a long wavelength, low divergence high-power laser system. This disclosure provides, for example, an arrangement that is suitable for power beaming, involving long wavelength high-power VECSELs mounted on a tracking system, transmitting light beams to for example a photodiode that converts the radiation into electricity. The photodiode is mounted on the object, and can be connected, for example, to a battery system, or directly to electrical engines for example. The VECSELs are advantageously compact, and emit high-power, and provide low divergence beams.

The above and other objects, features and advantages of the present invention and the manner of realizing them will become more apparent, and the invention itself will best be understood from a study of the following description with reference to the attached drawings showing some preferred embodiments of the invention.

### A BRIEF DESCRIPTION OF THE SEVERAL VIEWS OF THE DRAWINGS

FIG. 1 shows an exemplary possible implementation of a Vertical External Cavity Surface Emitting Laser (VECSEL) element 100. An active element of the VESCEL, comprising for example a plurality of quantum wells 106, is pumped with a laser diode 108. The laser cavity is formed by two mirrors, for example, two concave mirrors 107 and 103, eventually substituted or completed by diffractive elements 109 and 110.

The heat generated within the active element is diffused towards the heat sink 104 thanks to and via diamond plates 105 in contact with the active element 106.

The diffractive elements 109 and 110 can be directly formed in diamond and in the diamond plates 105.

The VECSEL element is compact and can emit very high power, in a single mode. Its beam can be very close to Gaussian, which makes it easy to collimate with simple optics. In addition, VECSEL elements can easily be put in matrices or arrays 102 to scale power up.

Thanks to their low footprint and mass, VECSEL elements or matrices 102 can directly be mounted on a mobile device MD of a base 101. 102 represents such a VECSEL element or elements, or matrix, eventually also including collimating optics.

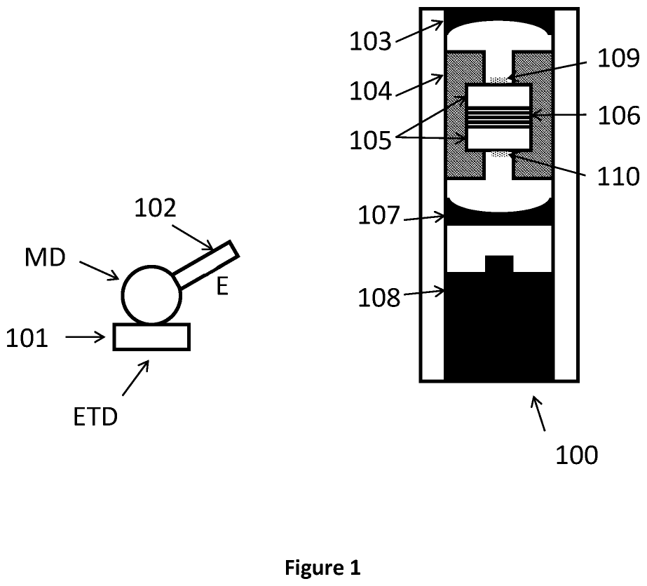

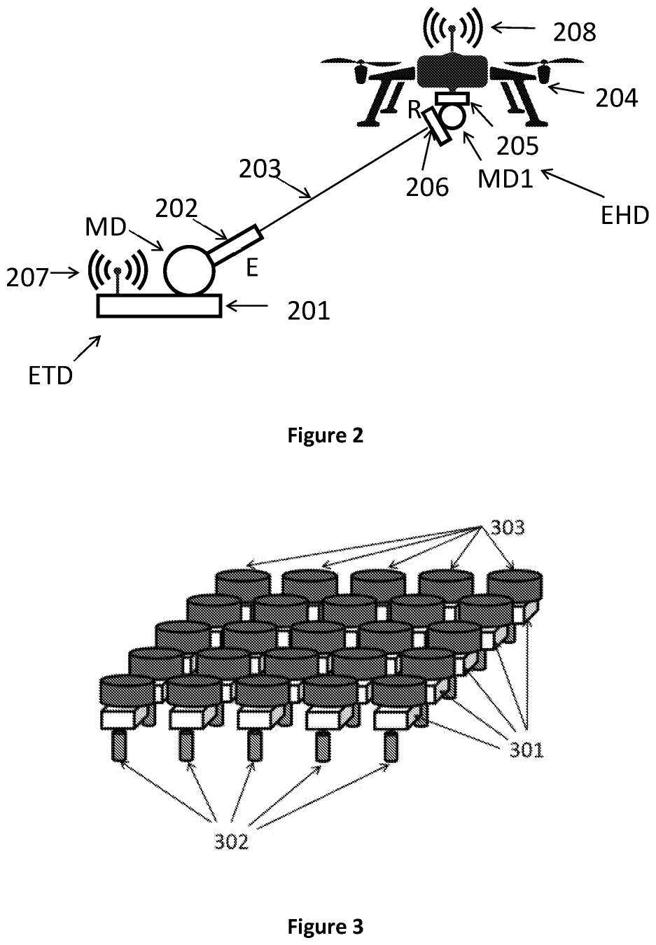

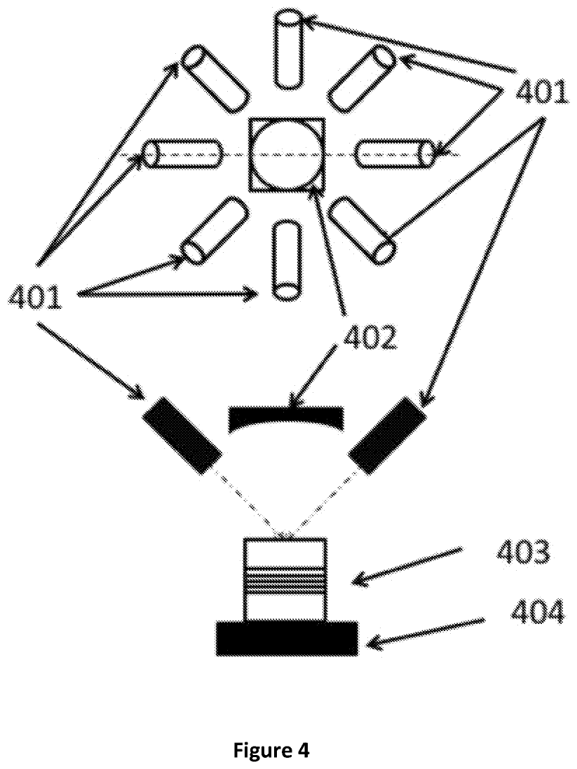

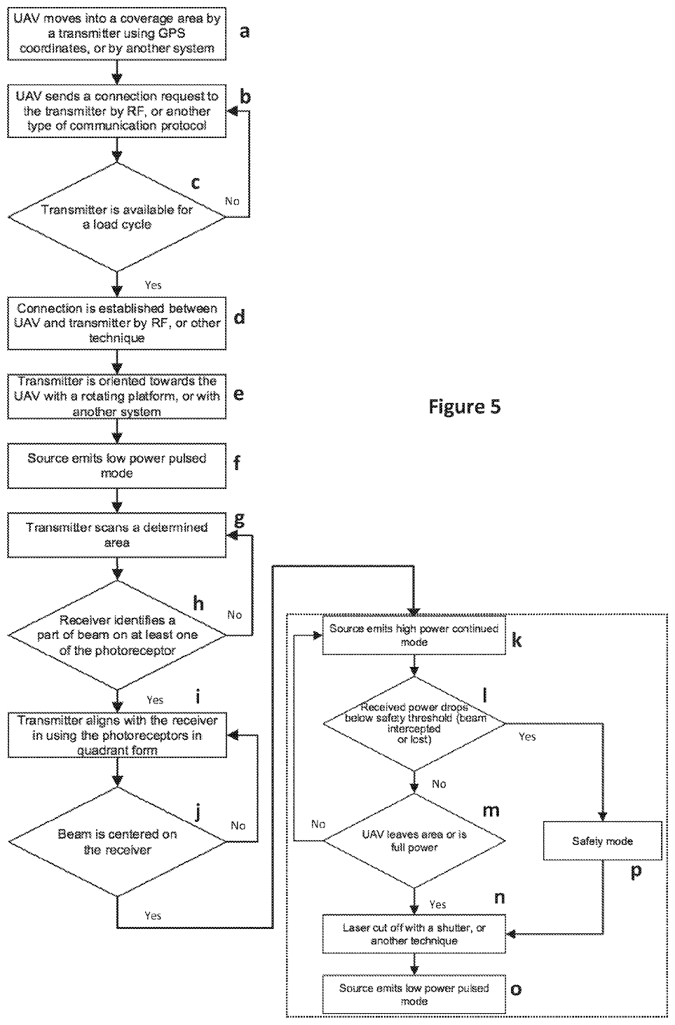

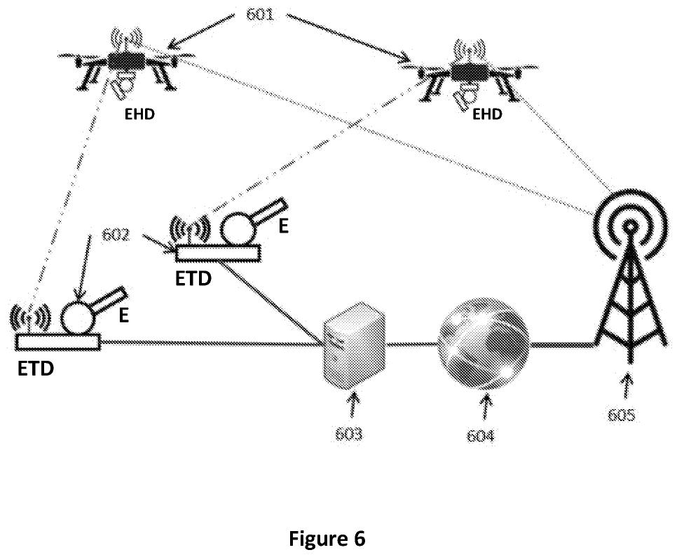

FIG. 1 also shows an exemplary energy transfer device ETD comprising an emitter mounted on a mobile device MD and a base 101.

FIG. 2 shows an exemplary overall power beaming system, comprising an emitter 102, 202 mounted on the mobile device MD of a base 101, 201, thanks to which the laser beam 203 can at all times be directed towards a receiver 206. The base 101, 201 is fixed or can be embarked on a vehicle, which can be a drone. The receiver 206 can also be mounted on a mobile device MD1 of a platform 205 so that the receiver surface, that can comprise, for example, a plurality of photodiode elements, can be orientated to be preferably positioned normal to the laser beam, minimizing hazardous reflections and maximizing the effective power received by the photodiodes.

The object 204 receiving the power is in this example a quadricopter UAV (unmanned aerial vehicle), but this present invention is applicable to any other moving or non-moving object.

Apparatus on both the UAV and the emitter ensemble, depicted as 207 and 208 in this FIG. 2, are used to establish communication between the UAV and the base 201. In particular, this information allows for establishing the tracking, and determining the moments when the laser beam should be brought to high power or maintained to low power.

FIG. 3 shows a possible implementation of VECSEL element as detailed in relation to FIG. 1 to form a matrix or array. Elements 301 each comprising, but not limited to, an active zone (for laser light emission) and a mirror are placed or arranged in parallel to form a matrix. Elements 303 each including, but not limited to, a mirror forming an external laser cavity with the element 301 in which the active zone is located. Each external laser cavity is pumped on the axis with a laser diode 302. Each active zone is optically pumped to generate laser light that is emitted from the optical cavity. This possible implementation increases the power of the source while retaining a compactness.

FIG. 4 shows a possible implementation to increase the power of a VECSEL element. The top section of the Figure shows a top view, and the bottom section of the Figure shows a cross-sectional view.

Laser diodes 401 for pumping are placed around an active element 403 (see bottom section), comprising for example a plurality of quantum wells, in order to increase the pump power. The laser cavity is formed by two mirrors 402 and 404 forming an external cavity.

FIG. 5 is an exemplary flow diagram that describes a protocol thanks to which energy transfer can be achieved or restored.

FIG. 6 shows a possible system implementation with the use of several transmitters. The system manages a UAV or drone fleet 601 that uses power beaming. A server 603 centralizes the information on the state of the transmitters 602 forming a network. When the drone needs to be refueled, it can connect directly to a nearby and available transmitter or query the server. The server is consulted through the internet network 604 which is accessible via mobile network 605.

Herein, identical reference numerals are used, where possible, to designate identical elements that are common to the figures.

### DETAILED DESCRIPTION OF THE SEVERAL EMBODIMENTS

The present disclosure provides a more efficient, safer power beaming system. An electromagnetic radiation source that has ideal properties for power beaming is provided. Another aspect relates to mounting this radiation source on a tracking device to follow the object to be powered. Another aspect relates to a protocol establishing the energy transfer efficiently and in a safe way. Yet another aspect relates to the component part of the object to be powered that converts the radiation power into electrical power.

The present invention relates to wireless transfer of energy. The transmitted energy allows to load or to supply an object with energy without any wires.

The system comprises at least an energy transfer device ETD including an energy source or emitter E, ground based or embarked on a vehicle, and an energy harvesting device EHD including a receiver R. The emitter E converts the electrical energy into electromagnetic radiation. Electromagnetic radiation is propagated in air, part of the atmosphere or other medium, and received by the receiver R that reconverts it into electrical energy. The object embarking the emitter may be mobile and moving. The emitter E can be composed of one or more sources. The source produces a laser beam, which is collimated. The beam is directed to the receiver R by a mobile platform.

The energy transfer device ETD transfer replenishment energy to a distant object. The energy transfer device comprises the energy source 102, 202 and a base 101, 201 configured to hold the energy source. The base is configured to displace the energy source 102, 202 relative to the base and/or orient the energy source 102, 202 towards the distant object as shown for example in FIG. 1 (left) and FIG. 2. The base 101 can, for example, include a motor to displace and/or orientate energy source 102.

The energy transfer device is, for example, configured to transfer replenishment energy over free-space to the distant object.

In a configuration, the energy source or emitter E is composed of or consists solely of a Vertical External Cavity Surface Emitting Laser (VECSEL), or a matrix or array comprising a plurality of Vertical External Cavity Surface Emitting Lasers (VECSELs). A possible arrangement of such a VECSEL matrix is shown in FIG. 3.

In a preferred implementation, the VECSEL comprises at least one active region, in direct contact with at least one element with low thermal impedance, inserted into a cavity.

The cavity can be formed by at least two highly reflective mirrors. In a configuration, the mirrors can be Distributed Bragg Reflectors, or concave mirrors, or high contrast gratings formed in the low thermal impedance material. For example, the low thermal impedance material consists solely of or includes diamond.

In a configuration, the emission of the laser that pumps the active region is not aligned with the output laser emission axis, configuration referred to as “Z configuration”. In another configuration, the emission of the laser that pumps the active region is aligned with the output laser emission axis, configuration referred to as “on-axis pumped VECSEL”, described in US2013028279 (U.S. Pat. No. 9,337,615) the entire contents thereof being herewith incorporated by reference.

FIG. 1 shows an exemplary implementation of a Vertical External Cavity Surface Emitting Laser (VECSEL) 100. An active element of the VESCEL, comprising for example a plurality of quantum wells 106, is pumped with a laser diode 108. The laser cavity is formed by two mirrors, for example, two concave mirrors 107 and 103, eventually substituted or completed by diffractive elements 109 and 110.

The heat generated within the active element is diffused towards the heat sink 104 thanks to and via diamond plates 105 in contact with the active element 106.

The diffractive elements 109 and 110 can be directly formed in diamond and in the diamond plates 105.

The VECSEL is compact and can emit very high power, in a single mode. Its beam can be very close to Gaussian, which makes it easy to collimate with simple optics. In addition, VECSEL elements can easily be put in matrices or arrays 102 to scale power up.

Thanks to their low footprint and mass, the VECSEL or matrices 102 thereof can directly be mounted on a mobile device MD of a base 101. 102 represents such a VECSEL element, or matrix of VECSELs, eventually also including collimating optics.

The base includes the mobile device MD that is configured to be displaced. The Vertical External Cavity Surface Emitting Laser or the plurality of Vertical External Cavity Surface Emitting Lasers can be mounted directly on the mobile device and displaced with the mobile device. The base 101 can, for example, include a motor to act on the mobile device MD to displace and/or orientate the mobile device MD and the energy source 102.

Collimating optical elements for collimating the laser emission can for example be mounted directly on the mobile device and be displaced with the mobile device.

The base 101, 201 is configured to hold the energy source and to orient the energy source towards the distant object. The base 101, 201 is configured to displace the energy source 102, 202 relative to the base to orient the energy source towards the distant object.

In an implementation, the VECSEL assembly emits at long wavelengths, typically suited for atmospheric transmission and eye/skin safety.

In a preferred implementation, the VECSEL assembly emits light with wavelength comprised for example between 1 μm and 3 μm (3 μm≥λ≥1 μm). These wavelengths can be achieved using III-V semiconductor material such as, but not limited to, GaInAsP, GaInAs, GaAs, AlGaAs, AlGaInAs. The VECSEL assembly can be configured to operate in continuous or in pulsed mode.

In an implementation, the VECSEL assembly is configured to emit the required power amount for the dedicated application. Typical power ranges may be limited to 10 W, in an implementation dedicated to low-power consumption objects. In other implementations dedicated to drones or any other object necessitating higher power, the VECSEL assembly emits powers comprised between 10 W and 10 kW (≥10 kW; ≤10 kW). In another implementation dedicated to powering for example very large unmanned vehicles, or manned vehicles, the VECSEL assembly emits power greater than 10 kW. The VECSEL assembly is typically suited for having emission powers over a broad range, since VECSELs can easily be put in matrices, scaling up the power by increasing the number of VECSEL elements within the VECSEL matrix. A possible arrangement of such VECSEL matrix is described in FIG. 3.

FIG. 3 shows a possible implementation of a VECSEL matrix or array. Elements 301 each comprising, but not limited to, an active zone (for laser light emission) and a mirror are placed or arranged in parallel to form a matrix. Elements 303 each including, but not limited to, a mirror forming an external laser cavity with the element 301 in which the active zone is located. Each external laser cavity is pumped on the axis with a laser diode 302. Each active zone is optically pumped to generate laser light that is emitted from the optical cavity. This possible implementation increases the power of the source while retaining a compactness.

Also described in FIG. 4 is an arrangement where the active layer is pumped by a plurality of pump lasers, allowing for an increase of output power of the VECSEL. FIG. 4 describes a possible implementation to increase the power of a VECSEL element. The upper section of the Figure shows a top view, and the lower section of the Figure shows a cross-sectional view. Laser diodes 401 for pumping are placed around an active element 403 (see bottom section), comprising for example a plurality of quantum wells, in order to increase the pump power. The laser cavity is formed by two mirrors 402 and 404 forming an external cavity. One of the mirrors can be for example a concave mirror.

The Energy transfer device may thus include a plurality of pumping lasers arranged to surround an active region of one Vertical External Cavity Surface Emitting Laser or each Vertical External Cavity Surface Emitting Laser of a plurality of Vertical External Cavity Surface Emitting Lasers to simultaneously optically pump the active layer.

In an implementation, depicted in FIG. 1, the active region, producing light, is placed between focusing mirrors, forming the cavity. The focusing mirrors are not in direct contact with the active region, leaving space to integrate elements within the cavity. In particular, a pumping element is usually used to optically pump the active and achieve lasing. In another configuration, described in US2013028279 (the entire contents thereof being herewith incorporated by reference), the mirrors consist of high contrast gratings etched in diamond, and the pump laser is in the same axis as the emission. This configuration has the advantage of compactness, and may be easily integrated on a tracking system in order to direct the laser beam directly onto the receiving object as shown for example in FIG. 2, without any intermediary active element (intermediary active element-less) such as a moving mirror. A possible implementation of the VECSEL element is depicted in FIG. 1.

In an implementation, the low impedance material is or includes diamond.

The Vertical External Cavity Surface Emitting Laser may comprise an external optical cavity in which is located a semiconductor active region configured to emit laser light at a first wavelength when optically pumped by a pumping laser providing laser energy at a second shorter wavelength.

The Vertical External Cavity Surface Emitting Lasers is for example configured to be optically pumped for laser emission along a laser emission output axis, or at an angle to the laser emission output axis.

The Vertical External Cavity Surface Emitting Laser may include a semiconductor action region and an optical cavity formed by mirrors not in direct contact with the semiconductor active region and defining a space within the optical cavity.

The vertical External Cavity Surface Emitting Laser may include an optical cavity, a semiconductor active region for emitting light inside the optical cavity and a low thermal impedance element 105 for evacuating thermal energy. The semiconductor active region can be in direct contact with the low thermal impedance element inserted inside a cavity.

The low thermal impedance element 105 can include at least one high contrast grating 109, 110.

The energy transfer device may include a first thermal impedance element 105 including a high contrast grating 109 and a second thermal impedance element 105 including a high contrast grating 110. The first and/or second thermal impedance elements 105 can be in direct contact with the semiconductor active region 106. The high contrast gratings 109, 110 are configured to reflect light into an optical cavity inside which the semiconductor active region 106 is located.

The low thermal impedance element or each thermal impedance element may comprise or consists solely of diamond.

The Vertical External Cavity Surface Emitting laser or Lasers may include a heat sink 104 in contact with the at least one or each low thermal impedance element.

The energy harvesting device EHD is configured to collect replenishment energy for the object. The energy harvesting device includes the energy receiver R configured to capture electromagnetic radiation energy from the energy source 102, 202 for one or more Vertical External Cavity Surface Emitting Lasers, and an energy converter configured to convert the received energy into electrical energy to power the object.

The energy harvesting device EHD further includes a base 205 configured to hold the energy receiver R and the energy converter. The base 205 is configured to orient the energy receiver R towards the Vertical External Cavity Surface Emitting Laser or lasers. The base 205 includes the mobile device MD1 configured to mount the receiver 206 thereon so that a receiver surface can be orientated to be positioned relative to the laser beam. The base 205 can, for example, include a motor to act on the mobile device MD1 to displace and/or orientate the mobile device MD1 and the receiver 206. The energy converter is configured to provide the converted energy to the object.

The receiver R is, for example, configured to capture electromagnetic radiation energy at a wavelength comprised between 1 μm and 3 μm.

The energy harvesting device may also include a RF transmitter and RF receiver for communicating with the energy transfer device.

The energy harvesting device EHD includes the receiver R which is composed of one or more components configured to receive the emitted energy and to convert the electromagnetic waves into electrical energy, such as a photovoltaic panel (or device) that can receive and carry out the energy conversion. The energy harvesting device EHD is configured to provide the electrical energy to the object to be replenished, for example through a power connection interface contained on the energy harvesting device EHD. The object may store the supplied energy or use the energy directly without storage. The energy harvesting device EHD may alternatively include a separate receiver device and separate converter device for energy conversion.

In an exemplary implementation, shown in FIG. 2, the receiver R is also mounted on an active platform to align with the emitter E. However, the platform of the receiver does not necessarily have to be configured for active alignment of the receiver. The energy harvesting device EHD can include an attachment for attaching the device to an object such as a UAV. Alternatively, the energy harvesting device EHD may be integrated into the object.

FIG. 2 shows an exemplary overall power beaming system, comprising an emitter 102, 202 mounted on the mobile device MD of the base (possibly mobile) 101, 201, thanks to which the laser beam 203 can at all times be directed towards a receiver 206.

The receiver 206 can also be mounted on a mobile device MD1 of a platform (possibly mobile) 205 so that the receiver surface, that can comprise, for example, at least one or a plurality of photodiode elements, can be orientated to be preferably positioned (substantially) normal to the laser beam, minimizing hazardous reflections and maximizing the effective power received by the photodiodes.

The object 204 receiving the power is in this example a quadricopter UAV (unmanned aerial vehicle), but this present invention is applicable to any other moving or non-moving object.

Apparatus on both the UAV and the emitter ensemble, depicted as 207 and 208 in this FIG. 2, are used to establish communication between the UAV and the base 201. In particular, this information allows for establishing the tracking, and determining the moments when the laser beam should be brought to high power or maintained to low power.

This active platform is particularly of interest since the power received by the photovoltaic panel depends on the relative orientation of the incoming beam and the surface of the photovoltaic panel. In particular, reflection of the incoming beam depends on this relative orientation. In an implementation, the surface of the photovoltaic panel is structured in order to minimize reflection of the incoming beam on the photovoltaic surface (anti reflection coating or structuring), and maximize the power received by the part converting light into electricity. The emitter and the receiver are synchronized by the exchange of some information such as their positions.

The energy harvesting device is configured to determine its geographical position data and to communicate this data to the energy transfer device.

The energy harvesting device EHD includes a tracking device configured to determine the geographical position of the Energy harvesting device. The tracking device for example comprises a GPS receiver and processor to determine the geographical position of the Energy harvesting device. The tracking device also includes a transmitter and antenna for transmitting the geographical position data by RF communication to the Energy transfer device, and also for transmitting other data relating to the function of the power beaming system. The Energy harvesting device EHD also includes a RF receiver and is configured to receive and process data sent by the Energy transfer device via RF communication.

The Energy harvesting device EHD include storage means, for example, a semiconductor memory or solid-state storage including one or more programs for controlling and implementing the different functions of the Energy harvesting device EHD including the RF communication, displacement of the mobile device MD1 to displace the receiver R to optimize laser energy reception incident thereon and/or other functions described in the present disclosure. This may optionally be done in association with a processor or calculator included the Energy harvesting device EHD.

The energy transfer device ETD can be identically equipped, and similarly includes a RF transmitter and receiver, it may however have its geographical position pre-stored in storage means (for example, a semiconductor memory or solid-state storage), eliminating the need for a GPS receiver. It additionally includes one or more programs to control operation of the Vertical External Cavity Surface Emitting Laser or the array of VECSELs and/or other functions described in the present disclosure. This may optionally be done in association with a processor or calculator included the Energy transfer device ETD.

The energy transfer device can include a RF transmitter and a RF receiver for communicating with the distant object.

The energy transfer device is, for example, configured to receive geographical position data of the distant object from the object by RF communication and to orient the energy source emission towards the received geographical position.

The tracking system serves the emitter E and the receiver R to know their respective positions to transmit the energy. The UAV knows its position thanks to a localization system like a GPS Chip and the emitter is stationary therefore this location is known and can be preset. The UAV transmits by radio frequency its position to the receiver of the Energy transfer device. Due to compactness of the source, it is mounted on the mobile device MD that is configured to be displaced simultaneously with the energy source to track the UAV. The Energy transfer device is configured to orient the mobile device and source directly to the receiver R of the energy harvesting device EHD based on the received geographical position of the receiver R and the known position of the Energy transfer device.

However, as the location may not have the precision expected (centimeter scale) because of the accuracy of the used location system (GPS: meter scale). The energy transfer device ETD is configured to displace the mobile device MD and the laser beam to scan the area where the drone can be located or is expected to be located based on the received geographical position data. During this phase, the energy transfer device ETD is configured to set the laser to low power emission to avoid any hazardous exposure. The receiver R alerts the Energy transfer device ETD via RF communication when it detects a part of the beam. The beam can be modulated (via a pulsed emission) and thus include a modulated signal to facilitate the receiver R and the energy harvesting device EHD identifying the emitter and the energy transfer device ETD. The energy harvesting device EHD is configured to demodulate the received signal and compare the demodulated signal with identification data of the energy transfer device ETD.

The energy transfer device can also be configured to displace the energy source to sweep or scan the emission beam of the energy source in a predefined zone to permit alignment of the beam with the distant object.

Once a part of the beam is intercepted by the receiver R, the receiver R is equipped with or includes, for example, several photoreceptors in order to then align the beam centrally or in the center, and keep it centrally aligned in real time.

The energy harvesting device is configured to communicate an alignment signal to the energy transfer device confirming that energy reception has occurred.

The energy transfer device may be configured to determine from a signal received from the object that energy reception has occurred, and to displace the energy source in reaction to a received alignment signal from the object representing an alignment level to optimise a received energy level at the object.

The technique consists for example in using the photoreceptors in quadrant form, the intensity received by each quadrant part permits the energy transfer device ETD to determine the position of the beam on a receiving surface of the receiver R and to determine whether it is centrally aligned for optimal energy reception and capture. Thus, the beam is centered when each quadrant at the same intensity. When the beam is aligned correctly, the laser will go to high power.

The energy harvesting device is, for example, configured to determine an alignment figure of merit value based on a distribution of received energy on the receiver R, and to communicate an alignment signal to the energy transfer device to guide displacement of a received emission beam by the energy transfer device. The alignment signal is for example determined based on said alignment figure of merit value.

The energy transfer device is, for example, configured to set the emission power level of the energy source to the energy transfer level higher than the alignment level and to continuous operation to energy replenish the object. The energy transfer device may alternatively or additionally be configured to operate in a high power mode, and also configured to adjust the power of the source to fit the distant object that needs to be replenished.

The energy transfer device can also be configured to set the emission power level of the energy source to (i) an alignment level during an alignment period in which an energy receiver R of the object is being aligned to a beam of the energy source to permit optimal energy transfer, and (ii) an energy transfer level during which energy replenishment of the object is carried out.

In high power mode, the power of the source is adjustable to fit the drone that needs to be replenished. Indeed, the received power can vary according to the model of drone. This information is transmitted by the energy harvesting device EHD to the energy transfer device ETD via RF communication. The power of the source can be adjusted by amplitude modulation. The power of the source means the light intensity produced by the source.

According to one embodiment, the energy transfer device ETD displaces the mobile device MD to improve alignment with the energy harvesting device EHD providing feedback via RF communication as to the improved or non-improved state of alignment. This is continued until optimal alignment is attained. Only, the mobile device MD of the energy transfer device ETD is moved. In another embodiment, the energy harvesting device EHD also displaces the receiver simultaneously or sequentially to the displacement of the mobile device MD and VECSEL of the energy transfer device ETD to permit faster alignment. Once alignment has been determined and communicated to the energy transfer device ETD, the energy transfer device ETD is configured to switch the VECSEL or VECSEL array to high power continuous operation for optimal energy transfer.

The time to transmit the energy, the drone can fly in a determined zone as long as it remains within the range of beam. An overall exemplary search and alignment protocol is described in FIG. 5.

The energy transfer device ETD and the energy harvesting device EHD are configured to intercommunicate and perform the data processing associated with the steps of the process and protocol set out in FIG. 5.

A first process includes steps a to k. A second process includes steps k to p. A third process includes all steps a to p.

FIG. 6 shows a possible method and system implementation with the use of several energy transfer devices 602. The system manages a UAV or drone fleet 601 that uses power beaming. A server 603 centralizes the information on the state of the energy transfer devices 602 forming a network. When a drone needs to be refueled, it can connect directly to a nearby and available energy transfer device 602 or query the server 603. The server is consulted through the internet network 604 which is accessible via mobile or cellular network 605 (for example, a GSM mobile network).

The server 603 includes a processor and storage means, for example, a semiconductor memory or solid-state storage including one or more programs for controlling and implementing the different functions described in the present disclosure.

The energy harvesting device is further configured to communicate with the mobile communications network to receive geographical position data of one or more energy transfer devices for providing replenishing electromagnetic radiation energy. The energy harvesting device may additionally be configured to communicate with the mobile communications network to receive geographical position data of one or more energy transfer devices currently available to provide replenishing electromagnetic radiation energy.

Each energy transfer device 602 includes a network communications device configured to communicate data to a central controller of the network (for example server 603), for example, status data of the energy transfer device 602, and can also be configured to receive data from server 603 and process this data.

The UAV 601 that needs to be recharged is directed to a coverage area of a transmitter of the energy transfer device 602. The position of the transmitter (energy transfer device) is recorded in the UAV or is received via the mobile network 605. The UAV is configured to fly by locating itself using a location system such as GPS. When the UAV is within the coverage area of the transmitter, both must establish a connection to exchange information such as their positions, the positioning of the beam on the photoreceptors of the receptor R, the battery charging level. The communication protocol preferably has a range of 1 km. Thus, as mentioned, radio frequency is suitable for this function. Frequency-hopping spread spectrum, FHSS, at 2.4 Ghz, for example, makes it possible to obtain the desired coverage area. The UAV sends a connection request and it is accepted if the energy transfer device is available to load it with energy. The transmitted signal is preferably resistant to interferences. When the data communication connection is established, the drone and the transmitter communicate so that the system is in closed loop.

According to a stored database, which can be updated on the drone, the drone is directed to a transmitter using stored GPS coordinates. In a possible implementation, several transmitters (energy transfer devices) can be connected to a common server and form a network. Each UAV can update its status of each transmitter by querying the server using a mobile network. Thus, there are two distinct communications: (i) the direct connection between the UAV and the transmitter, and (ii) the second, with the transmitter network. The transmitter network makes it possible to manage a fleet of drone, as described in FIG. 6. The system is configured to optimize the energy requirements of each drone according to different parameters such as: load, charging level, power consumption, destination, the position of transmitters . . . . For example, a drone less than 25% of battery power level and a drone more than 75%, the drone with the most available energy (all other parameters being similar) will recharge via an energy transfer device located further away and will leave the nearest transmitter to the drone with a low power level.

As mentioned above, the laser operates at low power during the phase of synchronization with the receiver. A standard defines the levels of power that must not be exceeded depending on the conditions of use. When the source is aligned and centered on the receiver, the laser switches to high power.

An object or a living entity can come between the receiver and the emitter, in which case, according to an embodiment of the present disclosure, the system is configured to reduce the power emitted by the emitter in order to satisfy the safety standard. In an implementation, the power emitted by the VECSEL assembly is reduced below a safety level if the receiver receives a power lower than a threshold power defined as a function of the distance between the emitter and the receiver, and atmospheric conditions. The overall alignment protocol is described in FIG. 5.

The energy harvesting device can also be configured to determine a drop in received energy below a predetermined threshold value, and to communicate a safety signal to the energy transfer device signalling the drop in received energy below the predetermined threshold value.

The energy transfer device is configured to stop or block emission from the energy source in response to the safety signal signalling a drop in received energy below a predetermined threshold value.

In a possible implementation, the receiver of the energy transfer device ETD is composed of several photodiodes embarked onto the object to be powered. The energy transfer device ETD can be composed of the mobile platform (as previously described) to orient the photodiodes independently of the UAV. In an implementation, several photodiodes are used to align the laser. The relative intensity received by each photodiode is used to determine the misalignment of the laser beam with the receiver. This information is communicated to the emitter to correct in real time the laser beam direction and maximize the laser intensity received by the photodiodes.

The characteristics of the photodiode are chosen to maximize the conversion efficiency of the electromagnetic waves into electrical energy. So, the photodiodes are preferably optimized for wavelength between 1 μm and 3 μm, or between 1 μm and 2 μm. The materials of photodiodes used in this range are germanium (Ge), gallium antimonide (GaSb) or indium gallium arsenide (InGaAs). In an implementation, an anti-reflection (AR) coating or structuring (AR treatment) is applied to photodiodes. AR treatment is used to minimize beam reflection by the photodiodes for safety and for energy conversion efficiency.

In a possible implementation, the object is for example an unmanned aerial vehicle (UAV). There are two types of electric UAV: Fixed wing and multi-rotor drone. The advantage of multi-rotor drones is their accuracy and stability in flight. Currently, multi-rotor drones are used in many areas: including, but not restricted to, delivery, inspection, communication. Power beaming extends their flight time and autonomy, which are crucial characteristics for most applications. Power beaming can be used to recharge the batteries of the UAV during flight, or minimize the battery size by sending energy during flight. This is of particular interest since batteries constitute a large part of the overall UAV weight.

The targeted UAV applications can be distinguished into two groups: Civil/commercial and homeland security. The first group includes: agriculture, aerial remote sensing, mining, media, product delivery, greenhouse emission monitoring, refueling, data transmission. The other group includes: border management, traffic monitoring, search, rescue, marine security, police operations and investigations. In addition to this non-exhaustive list of applications, power beaming can be used for other applications.

The present disclosure further concerns a power beaming system including the above-mentioned energy transfer device ETD, and energy harvesting device EHD.

The laser system is mounted on an apparatus such that its beams can reach a remote receiving unit fixed or mobile. The receiving system comprises a plurality of photodiodes mounted on an apparatus such that the laser beam is maintained normal to the surface of the photodiodes. The laser system includes, for example, a Vertical External Cavity Surface Emitting Laser matrix containing at least one VECSEL or a plurality of VECSELs, mounted on a moving platform, as well as collimating optics.

The system can be configured to carry out a lock-in procedure that involves a phase where the laser system scans space at a safe power until feedback from the receiving system permits to establish energy transfer.

The system can also be configured to trigger a safe mode when a significant reduction of power received by the receiver occurs to trigger a safe mode where emitted power is reduced below a safety level.

The laser system can operate in continued or pulsed mode and the receiving system is capable of detecting a pulsed signal. The receiving system is configured to identify the correct beam thanks to a specific temporal pattern or laser modulation.

The present disclosure further concerns a power beaming method comprising the step of providing the above-mentioned system and the step of carrying out power beaming.

While the invention has been disclosed with reference to certain preferred embodiments, numerous modifications, alterations, and changes to the described embodiments, and equivalents thereof, are possible without departing from the sphere and scope of the invention. The features of any one of the described embodiments may be included in any other of the described embodiments. The methods steps are not necessary carried out in the exact order presented above and can be carried out in a different order. Accordingly, it is intended that the invention not be limited to the described embodiments and be given the broadest reasonable interpretation in accordance with the language of the appended claims.

1-47. (canceled)

48. Energy transfer device for transferring replenishment energy to a distant object, the energy transfer device comprising:
an energy source,
a base configured to hold the energy source and to orient the energy source towards the distant object,
wherein the energy source comprises at least one Vertical External Cavity Surface Emitting Laser.

49. Energy transfer device according to claim 48, wherein the base is configured to displace the energy source relative to the base to orient the energy source towards the distant object.

50. Energy transfer device according to claim 48, wherein the energy source comprises an array including a plurality of Vertical External Cavity Surface Emitting Lasers, and the base is configured to hold the energy source and to orient the energy source towards the distant object.

51. Energy transfer device according to claim 48, wherein the base includes a mobile device configured to be displaced, the at least one Vertical External Cavity Surface Emitting Laser or the plurality of Vertical External Cavity Surface Emitting Lasers being mounted directly on the mobile device being displaced with the mobile device.

52. Energy transfer device according to claim 48, wherein the at least one or plurality of Vertical External Cavity Surface Emitting Lasers comprise or comprises an external optical cavity in which is located a semiconductor active region configured to emit laser light at a first wavelength when optically pumped by a pumping laser providing laser energy at a second shorter wavelength.

53. Energy transfer device according to claim 48, wherein the at least one or plurality of Vertical External Cavity Surface Emitting Lasers is or are configured to be optically pumped for laser emission along a laser emission output axis, or at an angle to the laser emission output axis.

54. Energy transfer device according to claim 48, wherein the at least one or plurality of Vertical External Cavity Surface Emitting Lasers include or includes a semiconductor action region and an optical cavity formed by mirrors not in direct contact with the semiconductor active region and defining a space within the optical cavity.

55. Energy transfer device according to claim 48, wherein the at least one or plurality of Vertical External Cavity Surface Emitting Lasers includes or include an optical cavity, at least one semiconductor active region for emitting light inside the optical cavity and at least one low thermal impedance element for evacuating thermal energy, the at least one semiconductor active region being in direct contact with the at least one low thermal impedance element inserted inside a cavity.

56. Energy transfer device according to claim 55, wherein the at least one low thermal impedance element includes at least one high contrast grating.

57. Energy transfer device according to claim 56, including a first thermal impedance element including a high contrast grating and a second thermal impedance element including a high contrast grating, the first and/or second thermal impedance elements being in direct contact with the at least one semiconductor active region, and the high contrast gratings reflecting light into an optical cavity inside which the at least one semiconductor active region is located.

58. Energy transfer device according to claim 55, wherein the at least one low thermal impedance element or each thermal impedance element comprises or consists solely of diamond.

59. Energy transfer device according to claim 55, wherein the at least one or plurality of Vertical External Cavity Surface Emitting Lasers includes or includes at least one heat sink in contact with the at least one or each low thermal impedance element.

60. Energy transfer device according to claim 48, further including a plurality of pumping lasers arranged to surround an active region of one Vertical External Cavity Surface Emitting Laser or each one of the Vertical External Cavity Surface Emitting Laser to simultaneously optically pump the active layer.

61. Energy transfer device according to claim 48, further including a RF transmitter and RF receiver for communicating with the distant object.

62. Energy transfer device according to claim 61, wherein the energy transfer device is further configured to receive geographical position data of the distant object from the distant object by RF communication and to orient the energy source emission towards said received geographical position.

63. Energy transfer device according to claim 61, wherein the energy transfer device is further configured to set the emission power level of the energy source to (i) an alignment level during an alignment period in which an energy receiver of the distant object is being aligned to a beam of the energy source to permit optimal energy transfer, and (ii) an energy transfer level during which energy replenishment of the distant object is carried out.

64. Energy transfer device according to claim 48, wherein the energy transfer device is further configured to modulate the emission of the energy source during an alignment period to allow the distant object to identify the Energy transfer device.

65. Energy transfer device according to claim 48, wherein the energy transfer device is configured to displace the energy source to sweep or scan the emission beam of the energy source in a predefined zone to permit alignment of the beam with the distant object.

66. Energy transfer device according to claim 48, wherein the energy transfer device is configured to stop or block emission from the energy source in response to a safety signal received from the distant object signalling a drop in received energy below a predetermined threshold value.

67. Energy transfer device according to claim 48, further including a network communications device configured to communicate status data of the energy transfer device to a central network controller configured to coordinate energy replenishment of a fleet of distant objects.
